(19) United States
(12) Patent Application Publication
(10) Pub. No.: US 2002/0093786 A1
(43) Pub. Date: Jul. 18, 2002

(54) Touch pad isolator

(76) Inventor: H. Barry Maser, Huntingdon Valley, PA (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 09/765,020

(22) Filed: Jan. 18, 2001

(51) Int. Cl. G06F 1/16

(52) U.S. Cl. 361/683

(57) ABSTRACT

A touch pad isolator for use with a computer having a touch pad pointing device. The touch pad isolator comprises a cover, attached to the computer adjacent a touch pad surface of the touch pad pointing device by means of a hinge which permits the cover to be rotated between a first position overlying the touch pad surface and a second position in which the touch pad surface is exposed.

### BACKGROUND OF THE INVENTION

The present invention relates to personal computers and more particularly to personal computers employing touch pads as pointing devices.

Many personal computers, particularly the portable variety, utilize a touch pad in lieu of or in addition to a mouse as a pointing device. Whereas a mouse is in the nature of a peripheral device which is plugged into the computer, a touch pad is incorporated into and forms an integral part of the computer. As such, touch pads facilitate the operation of the computer without the necessity of carrying, installing and using a peripheral mouse device. This enhances the portability of a laptop and other types of portable computers.

By moving a finger across the surface of the touch pad, a user can position an arrow or cursor at a desired location on the display screen of the computer. For example, when using a word processing application on the computer, text can be inserted into a document by moving a finger across the surface of the touch pad to place the cursor at the desired location within the document, then tapping the touch pad to initiate insertion.

Although touch pads can be an effective and convenient alternative to a mouse, particularly when used on portable computers, they can be a source of frustration when they operate inadvertently. For example, when using a word processing application, moving the hand across the keyboard can cause the touch pad to reposition the cursor and insert text at an undesired location. This can be prevented by electronically disabling the touch pad before using the program. However, such a procedure would require the substitution of a mouse or leave the user without the means to move the cursor.

### SUMMARY OF THE INVENTION

A touch pad isolator, attachable to a computer having a touch pad pointing device including a touch pad surface, said touch pad isolator comprising a cover which is moveable from a first position overlying the touch pad surface to at least a second position exposing the touch pad surface.

### BRIEF DESCRIPTION OF THE DRAWING

FIG. 1 is a diagrammatic, perspective view of a portion of a portable computer having a touch pad pointing device including a touch pad surface, having a touch pad isolator of the present invention installed thereon.

FIG. 2 is a diagrammatic, perspective view of that portion of the portable computer depicted in FIG. 1 depicting the touch pad isolator in position overlying the touch pad surface.

FIG. 3 is a diagrammatic, perspective view of that portion of the portable computer depicted in FIG. 1 depicting the touch pad isolator in a second position exposing the touch pad surface.

### DESCRIPTION OF THE INVENTION

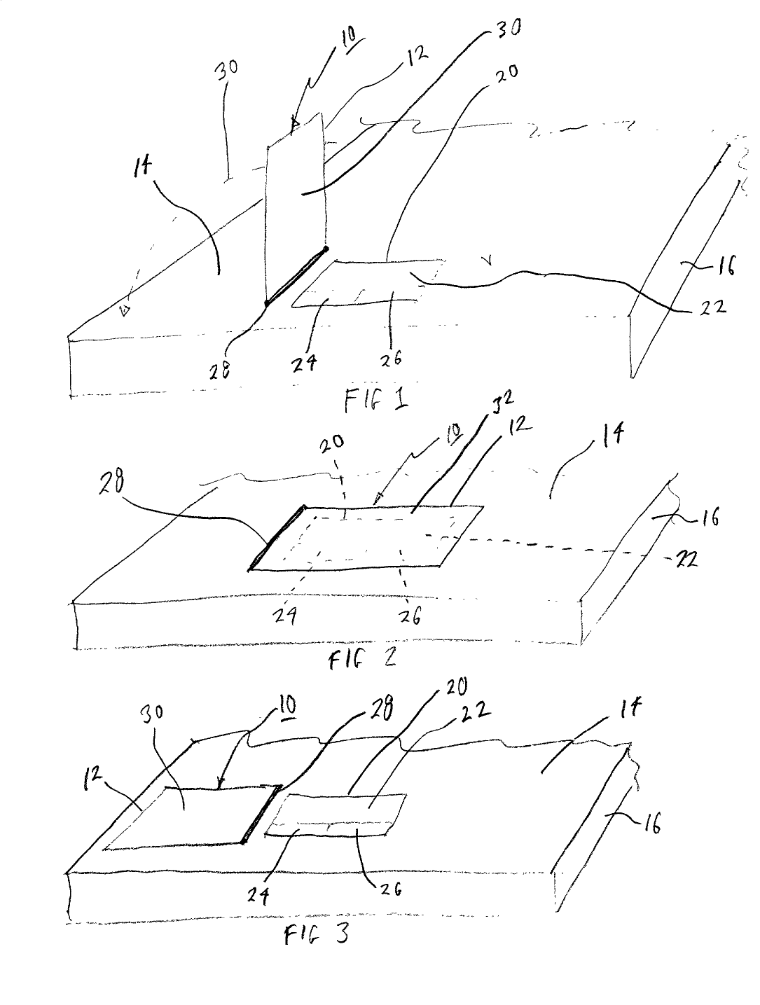

Referring to FIG. 1, there is depicted an embodiment of a touch pad isolator of the present invention generally designated 10. The touch pad isolator 10 comprises a cover 12 which is attached to a surface 14 of a computer 16 in proximity to a touch pad pointing device 20. The touch pad pointing device 20 includes a touch pad surface 22 and right and left click buttons 24 and 26 respectively.

In the embodiment depicted in FIG. 1, the cover 12 of the touch pad isolator 10 is attached to the surface 14 of the computer 16 by a hinge 28 which enables the cover 12 to be rotated as indicated by dotted line 30 from a first position overlying the touch pad surface 22 as depicted in FIG. 2, to a second position in which the touch pad surface is exposed as depicted in FIG. 3.

The cover 12 of the touch pad isolator 10 is preferably constructed of a material which imparts a degree of stiffness to the cover, such as plastic, poster board, cardboard or the like, which facilitates movement of the cover 12 from the first to the second positions. The hinge 28 may be directly attached to the surface 14 of the computer 16 by the manufacturer of the computer, or it may be removeably attached to the surface 14 of the computer 16 by the computer user by means of a releasable fastener such as velcro (not shown), or a glue-type fastening means such as a tacky or sticky, glue-type substance (not shown) which causes the hinge to releasably adhere to the surface 14. In the configuration where the hinge 28 is attached directly to the surface 14 by the manufacturer, the hinge 28 may be of a releasable type thus enabling the cover 12 to be replaced if desired.

The touch pad isolator 10 is used as follows. The hinge 28 is attached to the surface 14 of the computer 16 by the manufacturer or the user in relation to the touch pad pointing device 20 such that the cover 12 is rotatable from a first position overlying the touch pad surface 22 to a second position exposing the touch pad surface 22 as depicted in FIGS. 2 and 3 respictively. Thus, in those situations where the use of a pointing device is not desired, for example when typing text using a word processing application, the user rotates the cover 12 to the first position overlying the touch pad surface 22 as depicted in FIG. 2 which prevents inadvertent movement of the cursor caused by inadvertent contact with the touch pad surface 22. When use of the touch pad is desired, the cover 12 is rotated from the first position as depicted in FIG. 2 to a second position exposing the touch pad surface 22 as depicted in FIG. 3.

The touch pad isolator 10 of the present invention can be used to convey information, such as information of a promotional or advertising nature, by placing the desired text on either or both surfaces 30 and 32 of the cover 12. A touch pad isolator 10, with such information inscribed thereon, could make an attractive and useful promotional item. It may also be desirable to mount note pads, for example PostIt® type pads, on either or both surfaces 30 and 32 of the cover 12 and such is considered to be within the scope of the present invention.

In view of the above, it can be seen that using a touch pad isolator in accordance with the present invention will prevent inadvertent activation of the computer touch pad pointing device, when its use is not desired, while permitting its use at other times without the necessity of electronically disabling the touch pad pointing device. The touch pad isolator can also be beneficially used as a platform for advertising and/or promotional materials as well as for note pads.

I claim:

1. A touch pad isolator, attachable to a computer having a touch pad pointing device including a touch pad surface, said touch pad isolator comprising a cover which is moveable from a first position overlying the touch pad surface to at least a second position exposing the touch pad surface.

2. A touch pad isolator in accordance with claim 1 wherein said cover is hingedly attached to a surface of said computer in proximity to said touch pad surface whereby said cover is rotatable from said first position to said second position.

3. A touch pad isolator in accordance with claim 2 wherein said cover is releasably attached to a hinge which is attached to said computer surface.

4. A touch pad isolator in accordance with claim 2 wherein said cover is attached to a hinge which is releasably attached to said computer surface.

5. A touch pad isolator in accordance with claim 4 wherein said cover is attached to a hinge which is releasably attached to said computer surface using a velcro fastener.

6. A touch pad isolator in accordance with claim 4 wherein said cover is attached to a hinge which is releasably attached to said computer surface using a glue-type fastening means.

7. A touch pad isolator in accordance with claim 2 wherein at least one surface of said cover has textual material inscribed thereon.

8. A touch pad isolator in accordance with claim 2 including at least one writing pad is releasably attached to at least one surface of said cover.
